(19) United States
(12) Patent Application Publication
(10) Pub. No.: US 2026/0318534 A1
(43) Pub. Date: Oct. 15, 2026

(54) SYSTEM AND APPARATUS FOR REDUCING BOW WAVES IN GAS TURBINE ENGINES

(71) Applicant: General Electric Company, Evendale, OH (US)

(72) Inventors: Paul Hadley Vitt, Liberty Township, OH (US); Prem Venugopal, Clifton Park, NY (US); Thomas William Vandeputte, Scotia, NY (US)

(21) Appl. No.: 19/703,152

(22) Filed: Jun. 10, 2026

Related U.S. Application Data
(63) Continuation-in-part of application No. 18/609,120, filed on Mar. 19, 2024.

(51) Int. Cl. F23R 3/00; F02C 3/00

(52) U.S. Cl. CPC F23R 3/002; F02C 3/00

(57) ABSTRACT

A gas turbine engine includes a compressor section, a combustion section including an inner liner and an outer liner spaced from the inner liner, and a turbine section. The inner liner and outer liner at least partially define a combustion chamber. The turbine section includes an inner band extending between an upstream side and a downstream side opposite the upstream side and an outer band spaced from the inner band and extending between the upstream side and the downstream. The inner band and outer band at least partially define a working gas flow path. One or both of the inner band and the outer band include a step portion adjacent the upstream side and a body portion extending from the step portion to the downstream side. The step portion extends in a radial direction past the body portion.

### CROSS-REFERENCE TO RELATED APPLICATION

This application is a continuation in part application of U.S. application Ser. No. 18/609,120, filed Mar. 19, 2024, which is hereby incorporated by reference in its entirety.

### FIELD

The present disclosure relates to gas turbine engines and reducing bow wave effects at components of gas turbine engines.

### BACKGROUND

Turbine engines generally include a fan and a core section arranged in flow communication with one another. A combustor is arranged in the core section to generate combustion gases for driving a turbine in the core section of the turbine engine.

When the combustion gases approach an interface between the combustor and the turbine, a pressure or bow wave may reflect a portion of the combustion gases upstream, creating pressure variations and non-uniform pressure distribution between the combustor and the turbine. The pressure variations may cause the combustion gases to heat undesirable components of the turbine engine, which may decrease engine durability and result in decreased engine performance. Accordingly, systems and apparatuses for reducing bow wave effects within gas turbine engines are desirable.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic cross-sectional view of a gas turbine engine according to an exemplary embodiment of the present disclosure.

FIG. 2 is a side, cross-sectional view of a compressor section, a combustion section, and a turbine section of the gas turbine engine of FIG. 1 according to an exemplary embodiment of the present disclosure.

FIG. 3A is a top, detailed view of an interface between the combustion section and the turbine section of FIG. 2 according to an exemplary embodiment of the present disclosure.

FIG. 3B is a cross-sectional view through line III-III of the interface between the combustion section and the turbine section of FIG. 3A according to an exemplary embodiment of the present disclosure.

FIG. 3C is a schematic cross-sectional view of a first interface and a second interface of FIG. 2 according to an exemplary embodiment of the present disclosure.

FIG. 4A is a top, detailed view of an interface between the combustion section and the turbine section of FIG. 2 according to an exemplary embodiment of the present disclosure.

FIG. 4B is a cross-sectional view through line IV-IV of the interface between the combustion section and the turbine section of FIG. 4A according to an exemplary embodiment of the present disclosure.

FIG. 5 is a graphical representation of a portion of an inner band of the turbine section of FIGS. 3A-4B according to an exemplary embodiment of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a,” “an,” and “the” include plural references unless the context clearly dictates otherwise.

The term “at least one of” in the context of, e.g., “at least one of A, B, and C” refers to only A, only B, only C, or any combination of A, B, and C.

The term “turbine engine” refers to an engine having a turbomachine as all or a portion of its power source. Example turbine engines include turbofan engines, turboprop engines, turbojet engines, turboshaft engines, etc., as well as hybrid-electric versions of one or more of these engines.

The term “combustion section” refers to any heat addition system for a turbomachine. For example, the term combustion section may refer to a section including one or more of a deflagrative combustion assembly, a rotating detonation combustion assembly, a pulse detonation combustion assembly, or other appropriate heat addition assembly. In certain example embodiments, the combustion section may include an annular combustor, a can combustor, a cannular combustor, a trapped vortex combustor (TVC), or other appropriate combustion system, or combinations thereof.

The terms “upstream” and “downstream” refer to the relative direction with respect to fluid flow in a fluid pathway. For example, “upstream” refers to the direction from which the fluid flows, and “downstream” refers to the direction to which the fluid flows.

As used herein, the terms “axial” and “axially” refer to directions and orientations that extend substantially parallel to a centerline of the gas turbine engine. Moreover, the terms “radial” and “radially” refer to directions and orientations that extend substantially perpendicular to the centerline of the gas turbine engine. In addition, as used herein, the terms “circumferential” and “circumferentially” refer to directions and orientations that extend arcuately about the centerline of the gas turbine engine.

As used herein, a “bypass ratio” of a turbine engine is a ratio of bypass air through a bypass of the turbine engine to core air through a core inlet of a turbomachine of the turbine engine. For example, the bypass ratio is a ratio of bypass air 62 entering the bypass airflow passage 56 to core air 64 entering the turbomachine 16.

The terms “coupled,” “fixed,” “attached to,” and the like refer to both direct coupling, fixing, or attaching, as well as indirect coupling, fixing, or attaching through one or more intermediate components or features, unless otherwise specified herein.

As used herein, the terms “first,” “second,” and “third” may be used interchangeably to distinguish one component from another and are not intended to signify location or importance of the individual components.

For purposes of the description hereinafter, the terms “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations, except where expressly specified to the contrary. It is also to be understood that the specific devices illustrated in the attached drawings, and described in the following specification, are simply exemplary embodiments of the disclosure. Hence, specific dimensions and other physical characteristics related to the embodiments disclosed herein are not to be considered as limiting.

The term “adjacent” as used herein with reference to two walls and/or surfaces refers to the two walls and/or surfaces contacting one another, or the two walls and/or surfaces being separated only by one or more nonstructural layers and the two walls and/or surfaces and the one or more nonstructural layers being in a serial contact relationship (i.e., a first wall/surface contacting the one or more nonstructural layers, and the one or more nonstructural layers contacting a second wall/surface).

The present disclosure is generally related to reducing bow wave effects at an interface between components within gas turbine engines. Conventional gas turbine engines utilize extended bands or aft-facing steps between the combustor section and the turbine section to prevent ingestion of combustion gases. However, airflow stagnates at airfoil leading edges to create bow waves that reverse the airflow direction. Such reversal of airflow can cause gases to be ingested into gaps and undesirably increase the temperature of components of the gas turbine engine. The present disclosure utilizes a forward facing step on one or both of an inner band and outer band of the turbine section adjacent the combustion section to create a stagnation region. The stagnation region increases a static pressure within a cavity adjacent the forward facing step to resist bow-wave formation and the reversal of airflow. Accordingly, ingestion of combustion gases may be prevented, which reduces the need for additional cooling and improves durability of components of the gas turbine engine.

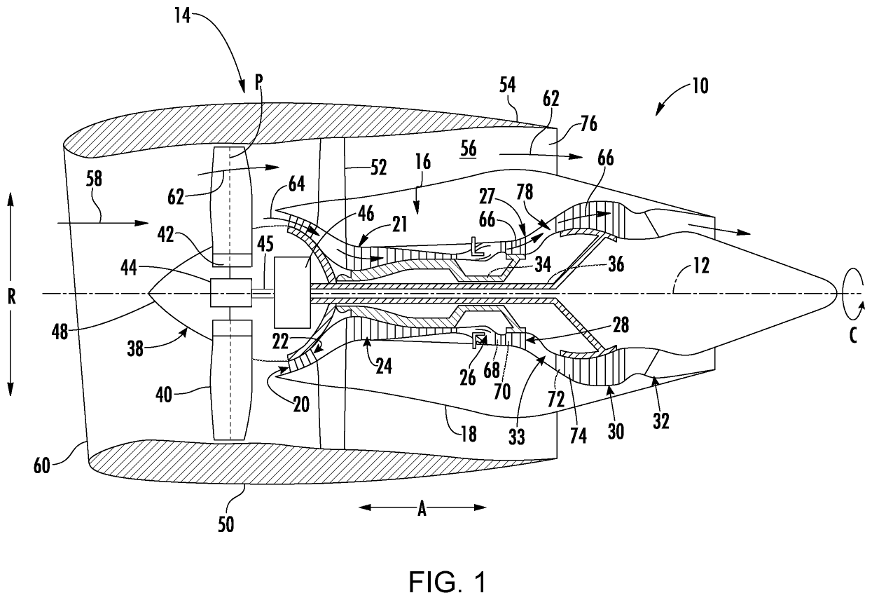

Referring now to the drawings, FIG. 1 is a schematic cross-sectional view of a turbine engine 10 according to an exemplary embodiment of the present disclosure.

As shown in FIG. 1, the turbine engine 10 has an axial direction A (extending parallel to a longitudinal centerline axis 12) and a radial direction R that is normal to the axial direction A. In general, the turbine engine 10 includes a fan section 14 and a turbomachine 16 disposed downstream from the fan section 14.

The turbomachine 16 includes an outer casing 18 that is substantially tubular and defines an annular core inlet 20. As schematically shown in FIG. 1, the outer casing 18 encases, in serial flow relationship, a compressor section 21 including a booster or a low-pressure compressor (“LPC”) 22 followed downstream by a high-pressure compressor (“HPC”) 24, a combustion section 26, a turbine section 27, including a high-pressure turbine (“HPT”) 28, followed downstream by a low-pressure turbine (“LPT”) 30, and one or more core exhaust nozzles 32. A high-pressure (“HP”) shaft 34 or a spool drivingly connects the HPT 28 to the HPC 24 to rotate the HPT 28 and the HPC 24 in unison. The HPT 28 is drivingly coupled to the HP shaft 34 to rotate the HP shaft 34 when the HPT 28 rotates. A low-pressure (“LP”) shaft 36 drivingly connects the LPT 30 to the LPC 22 to rotate the LPT 30 and the LPC 22 in unison. The LPT 30 is drivingly coupled to the LP shaft 36 to rotate the LP shaft 36 when the LPT 30 rotates. The compressor section 21, the combustion section 26, the turbine section 27, and the one or more core exhaust nozzles 32 together define a working gas flow path 33.

For the embodiment depicted in FIG. 1, the fan section 14 includes a fan 38 (e.g., a variable pitch fan) having a plurality of fan blades 40 coupled to a disk 42 in a spaced apart manner. As depicted in FIG. 1, the fan blades 40 extend outwardly from the disk 42 generally along the radial direction R. Each fan blade 40 is rotatable relative to the disk 42 about a pitch axis P by virtue of the fan blades 40 being operatively coupled to an actuator 44 configured to collectively vary the pitch of the fan blades 40 in unison. The fan blades 40, the disk 42, and the actuator 44 are rotatable together about the longitudinal centerline axis 12 via a fan shaft 45 that is powered by the LP shaft 36 across a power gearbox, also referred to as a gearbox assembly 46. The gearbox assembly 46 is shown schematically in FIG. 1. The gearbox assembly 46 includes a plurality of gears for adjusting the rotational speed of the fan shaft 45 and, thus, the fan 38 relative to the LP shaft 36.

Referring still to the exemplary embodiment of FIG. 1, the disk 42 is covered by a rotatable fan hub 48 aerodynamically contoured to promote an airflow through the plurality of fan blades 40. In addition, the fan section 14 includes an annular fan casing or a nacelle 50 that circumferentially surrounds the fan 38 and/or at least a portion of the turbomachine 16. The nacelle 50 is supported relative to the turbomachine 16 by a plurality of circumferentially spaced outlet guide vanes 52. Moreover, a downstream section 54 of the nacelle 50 extends over an outer portion of the turbomachine 16 to define a bypass airflow passage 56 therebetween. The one or more core exhaust nozzles 32 may extend through the nacelle 50 and be formed therein. In this exemplary embodiment, the one or more core exhaust nozzles 32 include one or more discrete nozzles that are spaced circumferentially about the nacelle 50. Other arrangements of the core exhaust nozzles 32 may be used including, for example, a single core exhaust nozzle that is annular, or partially annular, about the nacelle 50.

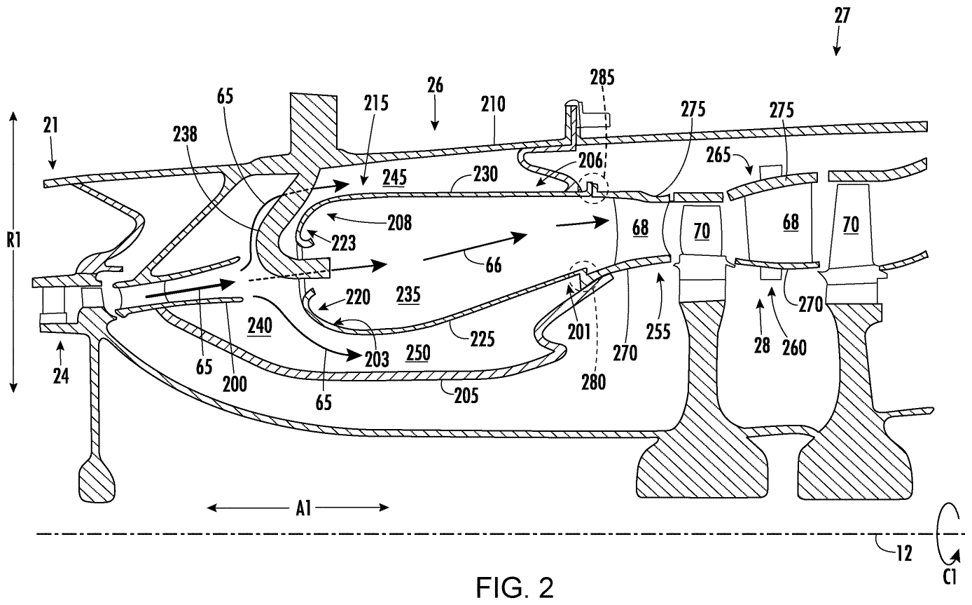

During operation of the turbine engine 10, a volume of air 58 enters the turbine engine 10 through an inlet 60 of the nacelle 50 and/or the fan section 14. As the volume of air 58 passes across the fan blades 40, a first portion of air (bypass air 62) is directed or routed into the bypass airflow passage 56, and a second portion of air (core air 64) is directed or is routed into the upstream section of the working gas flow path 33, or, more specifically, into the annular core inlet 20. The ratio between the first portion of air (bypass air 62) and the second portion of air (core air 64) is known as a bypass ratio. In some embodiments, the bypass ratio is greater than 18:1. The pressure of the core air 64 is then increased by the LPC 22, generating compressed air 65 (FIG. 2), and the compressed air 65 is routed through the HPC 24 and further compressed before being directed into the combustion section 26, where the compressed air 65 is mixed with fuel and burned to generate combustion gases 66 (combustion products). One or more stages may be used in each of the LPC 22 and the HPC 24, with each subsequent stage further compressing the compressed air 65. The HPC 24 has a compression ratio greater than 20:1, preferably, in a range of 20:1 to 40:1. The compression ratio is a ratio of a pressure of a last stage of the HPC 24 to a pressure of a first stage of the HPC 24. The compression ratio may be greater than 20:1.

The combustion gases 66 are routed into the HPT 28 and expanded through the HPT 28 where a portion of thermal energy and/or kinetic energy from the combustion gases 66 is extracted via sequential stages of HPT stator vanes 68 that are coupled to the outer casing 18 and HPT rotor blades 70 that are coupled to the HP shaft 34, thus, causing the HP shaft 34 to rotate, thereby supporting operation of the HPC 24. The combustion gases 66 are then routed into the LPT 30 and expanded through the LPT 30. Here, a second portion of thermal energy and/or the kinetic energy is extracted from the combustion gases 66 via sequential stages of LPT stator 72 that are coupled to the outer casing 18 and LPT rotor blades 74 that are coupled to the LP shaft 36, thus, causing the LP shaft 36 to rotate, thereby supporting operation of the LPC 22 and rotation of the fan 38 via the gearbox assembly 46. One or more stages may be used in each of the HPT 28 and the LPT 30. The HPC 24 having a compression ratio in a range of 20:1 to 40:1 enables the HPT 28 to have a pressure expansion ratio in a range of 1.5:1 to 4:1 and the LPT 30 having a pressure expansion ratio in a range of 4.5:1 to 28:1.

The combustion gases 66 are subsequently routed through the one or more core exhaust nozzles 32 of the turbomachine 16 to provide propulsive thrust. Simultaneously with the flow of the core air 64 through the working gas flow path 33, the bypass air 62 is routed through the bypass airflow passage 56 before being exhausted from a fan bypass nozzle 76 of the turbine engine 10, also providing propulsive thrust. The HPT 28, the LPT 30, and the one or more core exhaust nozzles 32 at least partially define a hot gas path 78 for routing the combustion gases 66 through the turbomachine 16.

As noted above, the compressed air 65 (the core air 64) is mixed with the fuel in the combustion section 26 to generate a fuel and air mixture, and combusted, generating combustion gases 66 (combustion products). The fuel can include any type of fuel used for turbine engines, such as, for example, sustainable aviation fuels (SAF) including biofuels, JetA, or other hydrocarbon fuels. The fuel also may be a hydrogen-based fuel (H₂), and, while hydrogen-based fuel may include blends with hydrocarbon fuels, the fuel used herein is preferably unblended, and referred to herein as hydrogen fuel. In some embodiments, the hydrogen fuel may comprise substantially pure hydrogen molecules (i.e., diatomic hydrogen). The fuel may also be a cryogenic fuel. For example, when the hydrogen fuel is used, the hydrogen fuel may be stored in a liquid phase at cryogenic temperatures.

The turbine engine 10 depicted in FIG. 1 is by way of example only. In other exemplary embodiments, the turbine engine 10 may have any other suitable configuration. For example, in other exemplary embodiments, the fan 38 may be configured in any other suitable manner (e.g., as a fixed pitch fan) and further may be supported using any other suitable fan frame configuration. Moreover, in other exemplary embodiments, any other suitable number or configuration of compressors, turbines, shafts, or a combination thereof may be provided. In still other exemplary embodiments, aspects of the present disclosure may be incorporated into any other suitable turbine engine, such as, for example, turbofan engines, propfan engines, turboprop engines, ground power generation machines, or a combination thereof.

FIG. 2 is a side, cross-sectional view of the compressor section 21, the combustion section 26, and the turbine section 27 of the turbine engine 10 of FIG. 1 according to an exemplary embodiment of the present disclosure. More specifically, a rear end of the HPC 24, the combustion section 26, and a forward end of the HPT 28 are illustrated.

Compressed air 65 exits the HPC 24 through an annular diffuser 200 located at the rear end or outlet of the HPC 24 and diffuses into the combustion section 26. The combustion section 26 of the turbomachine 16 is annularly encased by an inner combustor casing 205 and an outer combustor casing 210 radially spaced from the inner combustor casing 205. The radially spaced inner combustor casing 205 and the outer combustor casing 210 both extend generally along axial direction Al and surround a combustor assembly 215 in annular rings. The inner and outer combustor casings 205, 210 are joined together at the annular diffuser 200 at the forward end of the combustion section 26.

As shown, the combustor assembly 215 generally includes an inner liner 225 extending between a rear end 201 and a forward end 203 generally along the axial direction Al, as well as an outer liner 230 also extending between a rear end 206 and a forward end 208 generally along the axial direction Al. The inner and outer liners 225, 230 together at least partially define a combustion chamber 235 therebetween. The inner and outer liners 225, 230 are each attached to or formed integrally with an annular dome. More particularly, the annular dome includes an inner dome section 220 formed integrally with the forward end 203 of the inner liner 225 and an outer dome section 223 formed generally with the forward end 208 of the outer liner 230. Further, the inner and outer dome section 220, 223 may each be formed integrally (or alternatively may be formed of a plurality of components attached in any suitable manner) and may each extend along the circumferential direction C1 to define an annular shape. It should be appreciated, however, that in other example embodiments, the combustor assembly 215 may not include the inner and/or outer dome sections 220, 223; may include separately formed inner and/or outer dome sections 220,223 attached to the respective inner liner 225 and outer liner 230; or may have any other suitable configuration.

In at least one example embodiment, the turbine section 27 includes an inner band 270 and an outer band 275 radially spaced from the inner band 270. The inner band 270 and the outer band 275 define at least a portion of the working gas flow path 33 (FIG. 1). The HPT stator vanes 68 may extend into the working gas flow path from the inner band 270, the outer band 275, or both the inner band 270 and the outer band 275.

Referring still to FIG. 2, the combustor assembly 215 further includes a plurality of fuel air mixers 238 spaced along the circumferential direction C1 and positioned at least partially within the annular dome. More particularly, the plurality of fuel air mixers 238 are disposed at least partially between the outer dome section 223 and the inner dome section 220 along the radial direction R1. Compressed air 65 from the compressor section 21 of the turbine engine 10 flows into or through the plurality of fuel air mixers 238, where the compressed air 65 is mixed with fuel and ignited to create combustion gases 66 within the combustion chamber 235. The inner and outer dome sections 220, 223 are configured to assist in providing such a flow of the compressed air 65 from the compressor section 21 into or through the plurality of fuel air mixers 238.

As discussed above, the combustion gases 66 flow from the combustion chamber 235 into and through the turbine section 27 of the turbine engine 10, where a portion of thermal and/or kinetic energy from the combustion gases 66 is extracted via sequential stages of turbine stator vanes and turbine rotor blades within the HPT 28 and LPT 30. More specifically, as is depicted in FIG. 2, combustion gases 66 from the combustion chamber 235 flow into the HPT 28, located immediately downstream of the combustion chamber 235, where thermal and/or kinetic energy from the combustion gases 66 is extracted via sequential stages of HPT stator vanes 68 and HPT rotor blades 70.

As illustrated in FIG. 2, not all compressed air 65 flows into or directly through the plurality of fuel air mixers 238 and into the combustion chamber 235. Some of the compressed air 65 is discharged into a plenum 240 surrounding the combustor assembly 215. Plenum 240 is generally defined between the inner and outer combustor casings 205, 210 and the inner and outer liners 225, 230. The outer combustor casing 210 and the outer liner 230 define an outer plenum 245 generally disposed radially outward from the combustion chamber 235. The inner combustor casing 205 and the inner liner 225 define an inner plenum 250 generally disposed radially inward with respect to the combustion chamber 235. As compressed air 65 is diffused by the annular diffuser 200, some of the compressed air 65 flows radially outward into the outer plenum 245 and some of the compressed air 65 flows radially inward into the inner plenum 250.

The compressed air 65 flowing radially outward into the outer plenum 245 flows generally axially to the turbine section 27. Specifically, the compressed air 65 flows above the HPT stator vanes 68 and the HPT rotor blades 70. The outer plenum 245 may extend to the LPT 30 (shown in FIG. 1) as well.

As further shown in FIG. 2, for the embodiment depicted, the HPT 28 includes a first stage 255 of the HPT stator vanes 68 and a second stage 260 of the HPT stator vanes 68 (as well as a first and second stage of the HPT rotor blades 70). Moreover, for the embodiment depicted, the second stage 260 of HPT stator vanes 68 is of a variable configuration, such that the second stage 260 of HPT stator vanes 68 includes a plurality of variable guide vane assemblies 265.

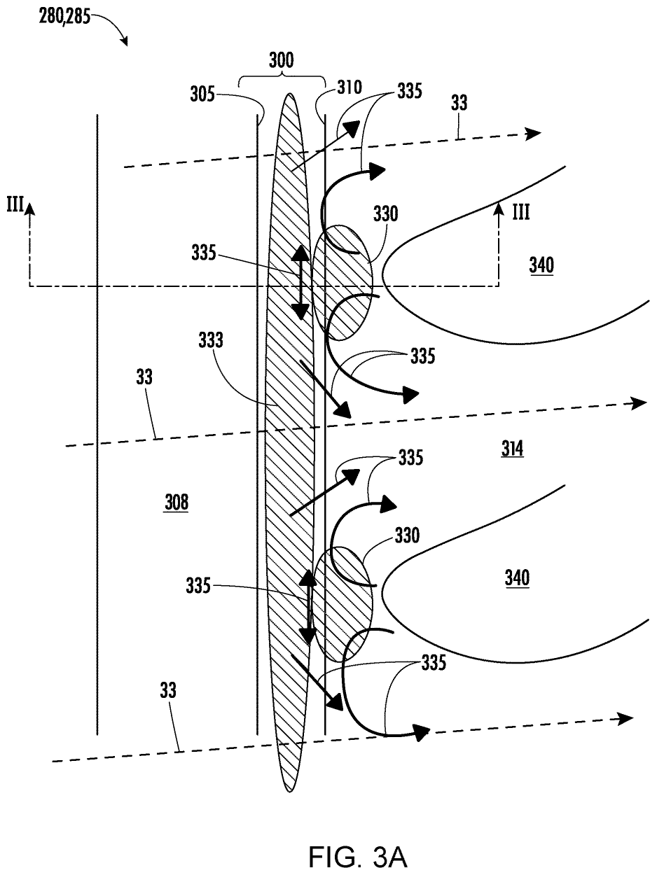

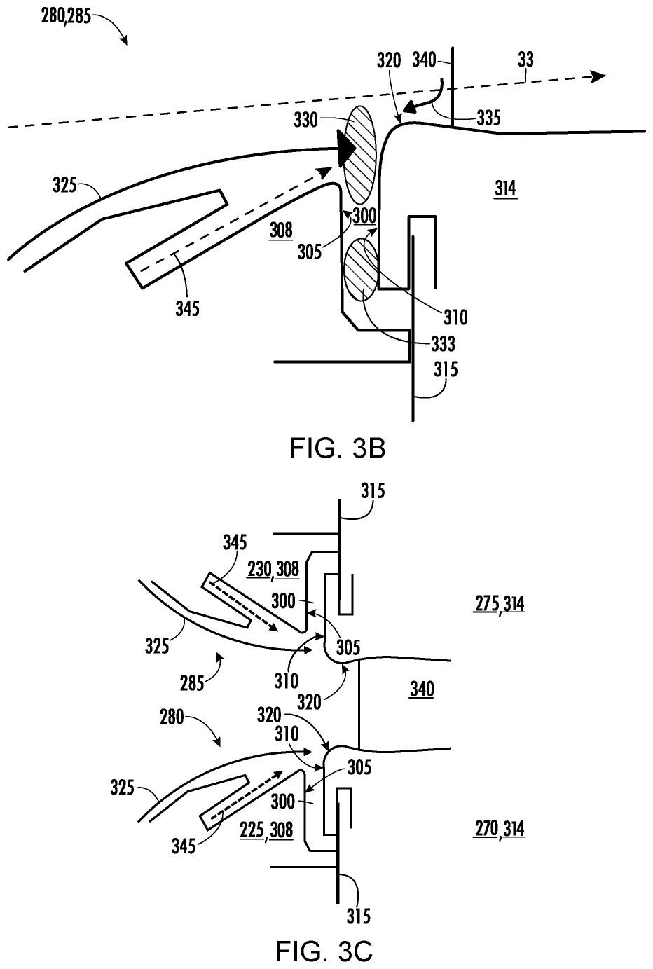

FIG. 3A is a top, detailed view of an interface between the combustion section 26 and the turbine section 27 of FIG. 2 according to an exemplary embodiment of the present disclosure. FIG. 3B is a cross-sectional view through line III-III of the interface between the combustion section 26 and the turbine section 27 of FIG. 3A according to an exemplary embodiment of the present disclosure. FIG. 3C is a schematic cross-sectional view of the first interface 280 and the second interface 285 of FIG. 2 according to an exemplary embodiment of the present disclosure. More specifically, a first interface 280 (shown in FIG. 2) between the inner liner 225 and the inner band 270 (FIG. 2) and a second interface 285 (shown in FIG. 2) between the outer liner 230 and the outer band 275 (FIG. 2) are illustrated in FIGS. 3A-3C.

In at least one example embodiment, one or both of the first interface 280 and the second interface 285 defines a gap, such as a cavity 300, between a downstream side 305 of a liner 308 and an upstream side 310 of a band 314. The liner 308 and the band 314 may be incorporated into the gas turbine engine 10 as the inner liner 225 and the inner band 270 (e.g., at the first interface 280 shown in FIG. 2). Additionally, or alternatively, the liner 308 and the band 314 may be incorporated into the gas turbine engine 10 (FIG. 1) as the outer liner 275 and the outer band 230 (e.g., at the second interface 285 shown in FIG. 2).

With reference to FIG. 3B, the downstream side 305 of the band 314 and the upstream side 310 of the band 314 may extend towards the inner combustor casing 205 (shown in FIG. 2). Accordingly, the cavity 300 also extends towards the inner combustor casing 205. Additionally, a seal 315 may be disposed between the liner 308 and the band 314. The seal 315 may define at least a portion of the cavity 300. In at least one example embodiment, the seal 315 is flexible.

Referring to FIG. 3B, in at least one example embodiment, at least a portion of an upstream side 310 of the band 314 extends at least partially into the working gas flow path 33 (FIG. 1), such as into the flow path of the combustion gases 66 from the combustion chamber 235 shown in FIG. 2. For example, the upstream side 310 of the band 314 includes a step portion 320 adjacent the liner 308 and extending into the working gas flow path 33. As shown in FIG. 3B, at least a portion of the step portion 320 may have a substantially concave shape. Additionally, or alternatively, the upstream side 310 of the outer band 275 (FIG. 2) may include the step portion 320 adjacent the outer liner 230 and extending into the working gas flow path 33. In such embodiments, the step portion 320 of the outer band 275 may be similar or analogous to the step portion 320 discussed herein. For example, FIG. 3C illustrates an exemplary embodiment where both the inner band 270 and the outer band 275 include in the step portion 320.

In at least one example embodiment, at least a first portion 325 of the combustion gases 66 (FIG. 2) through the working gas flow path 33 stagnates on the upstream side 310 of the step portion 320. Such stagnation at the step portion 320 creates a stagnation region 330 adjacent the upstream side 310 of the step portion 320. The stagnation region 330 is a region of high pressure which pressurizes the cavity 300. Accordingly, the stagnation region 330 pressurizes the cavity 300 such that the cavity 300 defines a high pressure zone 333, as shown in FIG. 3B. For example, an overall static pressure within the cavity 300 is increased.

In at least one example embodiment, at least a second portion 335 of the working gas flow path 33 stagnates on an upstream edge of a plurality of airfoils 340 extending from the band 314. The plurality of airfoils 340 may include the HPT stator vanes 68 discussed above with respect to FIGS. 1-2. Without the step portion 320, the second portion 335 of the working gas flow path 33 may stagnate on the airfoil 340 and create a bow wave that drives the second portion 335 to a low-pressure zone, such as into the cavity 300. However, the stagnation region 330 and the high pressure zone 333 prevents the second portion 335 of the working gas flow path 33 from flowing into the cavity 300 from the plurality of airfoils 340. Rather, as shown in FIG. 3A, the second portion 335 of the working gas flow path 33 is directed away from the cavity 300 by the stagnation region 330 and the high pressure zone 333 and around the airfoil 340 such that the second portion 335 continues along the working gas flow path 33. Accordingly, hot air from the working gas flow path 33, such as the combustion gases 66, are prevented from entering the cavity 300 and flowing to other components of the turbine engine 10. If such hot air from the working gas flow path 33 were ingested by the cavity, the temperature of components within the turbine engine 10 may be undesirably increased, which would require additional cooling.

In at least one example embodiment, the cavity 300 may become cooler at higher pressure because hot fluids or gases, such as the combustion gases 66, cannot enter the cavity 300. Accordingly, an amount of cooling air, indicated by arrow 345 in FIG. 3B, required to cool the cavity 300 may be reduced. For example, as shown in FIG. 2, cooling air may enter the cavity 300 from the inner plenum 250 via the first interface 280 in some example embodiments. Reducing the amount of cooling air required may improve engine performance while maintaining the durability of components of the turbine engine 10 because less air is bypassing the combustion chamber 235.

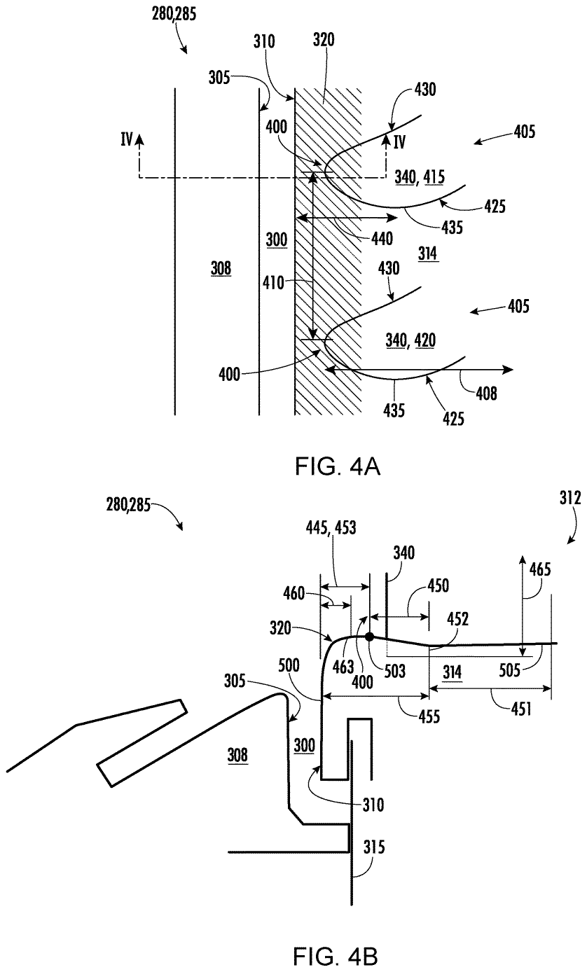

FIG. 4A is a top, detailed view of the first interface 280 between the combustion section 26 and the turbine section 27 of FIG. 2 according to an exemplary embodiment of the present disclosure. FIG. 4B is a cross-sectional view through line IV-IV of the first interface 280 between the combustion section 26 and the turbine section 27 of FIG. 4A according to an exemplary embodiment of the present disclosure. More specifically, dimensions associated with the first interface 280, shown in FIG. 2 and discussed above with respect to FIGS. 3A-3B, are illustrated. It should be understood that an interface between the outer liner 230 and the outer band 275 may be similar or analogous to the first interface 280 in some example embodiments.

With reference to FIG. 4A, the plurality of airfoils 340 include an upstream end 400 and a downstream end 405 opposite the upstream end 400. Each of the plurality of airfoils 340 may include an airfoil length 408 extending between the upstream end 400 and the downstream end 405. In at least one example embodiment, the airfoil length 408 is equal to an airfoil height 465, as will be described below with respect to FIG. 4B, between the band 314 and the outer band 275. In at least one additional example embodiment, the airfoil length 408 may be greater than or equal to 0.66 times a difference between a radius of the outer band 275 and a radius of the band 314. In other example embodiments, the airfoil length 408 may be less than 0.66 times a difference between a radius of the outer band 275 and a radius of the band 314.

In at least one example embodiment, the plurality of airfoils 340 are spaced apart from adjacent ones of the plurality of airfoils 340 an airfoil distance 410. For example, the plurality of airfoils 340 may include a first airfoil 415 and a second airfoil 420 spaced apart from the first airfoil 415. The upstream end 400 of the first airfoil 415 may be spaced apart the airfoil distance 410 from a same point on the upstream end 400 of the second airfoil 420. In at least one example embodiment, the airfoil distance 410 divided by the airfoil length 408 may be between 1 and 3.

Still referring to FIG. 4A, each of the plurality of airfoils 340 include a first surface 425 and a second surface 430 opposite the first surface 425. The first surface 425 and the second surface 430 extend between the upstream end 400 and the downstream end 405 of each of the plurality of airfoils 340. In at least one example embodiment, the first surface 425 of each of the plurality of airfoils 340 include a tangency point 435 between the upstream end 400 and the downstream end 405. The tangency point 435 of each of the plurality of airfoil 340 may be spaced from the upstream side 310 of the band 314 a tangency distance 440. In at least one example embodiment, the tangency distance 440 is greater than or equal to 0.3 or less than or equal to 0.9 times the airfoil length 408. In other example embodiments, the tangency distance 440 may be less than 0.3 times the airfoil length 408. In still other example embodiments, the tangency distance 440 may be greater than 0.9 times the airfoil length 408.

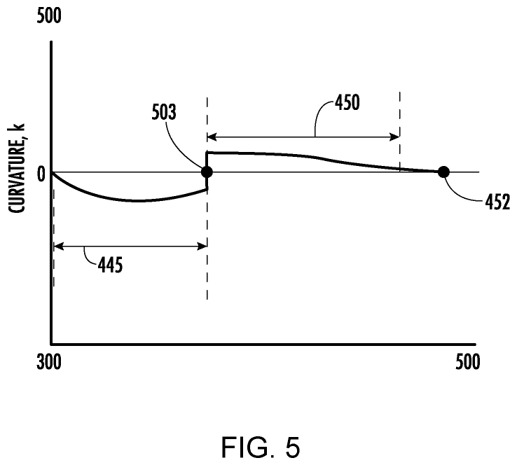

Referring now to FIG. 4B, the band 314 extends between the upstream side 310 and the downstream side 312. The inner band includes the step portion 320 adjacent the upstream side 310 and a body portion 451 extending from the step portion to the downstream side 312. The body portion 451 extends from the step portion to the downstream side 312, such as to the trailing edge 505, of the band 314. The step portion 320 extends between a leading edge 500 of the band 314 and an endpoint 452 along the band 314. The endpoint 452 is spaced between the leading edge 500 and the trailing edge 505 of the band 314. For example, the endpoint 452 may be adjacent the airfoil 340 between the leading edge 500 and the trailing edge 505. The endpoint 452 indicates a point along the band 314 at which the step portion 320 ends. For example, a radius of curvature at the endpoint 452 may be zero, as will be discussed below with respect to FIG. 5.

The step portion 320 extends in the radial direction R (shown in FIG. 1) past the body portion 451. Additionally, the step portion 320 includes a first curve 445 and a second curve 450 adjacent the first curve 445. The first curve 445 may be adjacent the upstream side 310 of the band 314 and the second curve 450 may be opposite the upstream side 310 and adjacent the plurality of airfoils 340. Moreover, the first curve 445 extends from the leading edge 500 to an inflection point 503 between the leading edge 500 and the endpoint 452. For example, the inflection point 503 may be positioned at any point along the band 314 between the leading edge 500 and the endpoint 452. Additionally, the second curve 450 extends from the inflection point 503 to the endpoint 452 and may further extend towards the trailing edge 505 adjacent a downstream side 312 of the band 314 opposite the upstream side 310.

In at least one example embodiment, the step portion 320 includes a peak distance 460 in the axial direction A (shown in FIG. 1) between the upstream side 310 of the band 314 and a maximum height, such as a peak 463, of the first curve 445 extending in the radial direction R (shown in FIG. 1). The peak 463 of the step portion 320 may be between the leading edge 500 of the band 314 and the upstream end 400 of the plurality of airfoils 340. In at least one example embodiment, the peak distance 460 is greater than or equal to 0.01 and less than or equal to 0.4 times the airfoil length 408. When the peak distance 460 is 0.01 times the airfoil length 408, this results in a generally vertical face at the leading edge 500 and the upstream side 310 of the band 314. In some additional example embodiments, the peak distance is greater than or equal to 0.1 and less than or equal to 0.2 times the airfoil length 408. In such embodiments, the peak 463 may be positioned upstream of the airfoil 340, which allows the step portion 320 to contour or curve more smoothly from the upstream side 310 towards the downstream side 312.

In other example embodiments, the peak distance 460 may be less than 0.01 times the airfoil length 408. In still other example embodiments, the peak distance 460 may be greater than 0.4 times the airfoil length 408.

Additionally, the peak distance 460 may be greater than or equal to 0.05 and less than or equal to 1.0 times the distance between the leading edge 500 of the band 314 and the upstream end 400 of the plurality of airfoils 340. Moreover, a ratio of the peak distance 460 over the first curve length 453 may be greater than or equal to 0.1 and less than or equal to 1.

In other example embodiments, the peak distance 460 may be less than 0.05 times the distance between a leading edge 500 of the band 314 and the upstream end 400 of the plurality of airfoils 340. In still other example embodiments, the peak distance 460 may be greater than 1.0 times the distance between a leading edge 500 of the band 314 and the upstream end 400 of the plurality of airfoils 340.

In at least one example embodiment, the step portion 320 includes a step length 455. The step length 455 includes a length, in the axial direction A (shown in FIG. 1), of both the first curve 445 and the second curve 450. Moreover, the step length 455 includes a length, in the axial direction A (shown in FIG. 1), between the leading edge 500 and the endpoint 452. In at least one example embodiment, the step length 455 may be less than or equal to the tangency distance 440. For example, the step length 455 may be 0.2 to 0.9 times the tangency distance 440. Moreover, the step length 455 may be less than the tangency distance 440 such that the step portion 320 terminates prior to reaching the Mach region of the gas turbine engine 10 in order to prevent airfoil losses. In some additional example embodiments, the step length 455 may be less than or equal to 0.9 times the airfoil length 408.

Additionally, the first curve 445 includes a first curve length 453 extending between the upstream side 310 of the band 314 and an end of the first curve 445 (indicated by the inflection point 503) adjacent the second curve 450. In at least one example embodiment, the first curve length 453 may be greater than or equal to 0.1 and less than or equal to 0.9 times a difference between the step length 455 from the peak distance 460. Accordingly, a length of the second curve 450 may be the difference between the step length 455 and the first curve length 453. The first curve length 453 may be greater than the length of the second curve 450 such that the inflection point 503 of the step portion 320 is downstream of the peak 463 of the first curve 445. Moreover, a ratio of the step length 455 over the tangency distance 440 (shown in FIG. 4A) may be greater than or equal to 0.05 and less than or equal to 1.

In at least one example embodiment, each of the plurality of airfoils 340 include the airfoil height 465. The airfoil height 465 may extend between the inner band 270 and the outer band 275 (shown in FIG. 2). The airfoil height 465 may vary between the upstream end 400 and the downstream end 405.

FIG. 5 is a graphical representation of a portion of the band 314 of the turbine section 27 of FIGS. 3A-4B according to an exemplary embodiment of the present disclosure. More specifically, FIG. 5 illustrates a curvature of the step portion 320 of the band 314.

In at least one example embodiment, the band 314 includes multiple curvatures between the leading edge 500 and the trailing edge 505 of the step portion 320. More specifically, the step portion 320 of the band 314 may have at least two curvatures between the leading edge 500 and the endpoint 452 between the leading edge 500 and the trailing edge 505 of the band 314. For example, the step portion 320 of the band 314 may include a curvature change at the inflection point 503. The inflection point 503 may be a point along the band 314 at which the curvature of the step portion 320 changes. For example, the curvature of the step portion 320 of the band 314 may change from a negative concavity, or a convex shape, to a positive concavity, or concave shape, at the inflection point 503.

As shown in FIG. 4B, the first curve 445 includes a substantially convex shape and the second curve 450 includes a substantially concave shape. With reference to FIG. 5, this is represented by the negative concavity of the first curve 445 and the positive concavity of the second curve 450. The concavity changes at the inflection point 503 between the first curve 445 and the second curve 450. In at least one example embodiment, the curvature of at least the step portion 320 of the band 314 may be represented by the following equation:

$$k = \frac{{y}^{″}}{{( 1 + {y}^{′ 2} )}^{3 / 2}}$$

A positive concavity, or concave curvature, occurs when k>1 and a negative concavity, or convex curvature, occurs when k<1. The value for k may be approximated by using the second derivative of a radial coordinate relative to an axial coordinate, which is represented by the following equation:

$$k \approx {y}^{″} = \frac{{\partial }^{2} y}{\partial {x}^{2}}$$

In the above equation, y is a radius, such as a radius extending in the radial direction R in FIG. 1, and x is an axial distance, such as an axial distance extending along the axial direction A in FIG. 1.

While FIG. 5 illustrates the concavity of the endpoint 452 at 0, it should be understood that in other example embodiments the concavity at the endpoint 452 may be greater than or less than 0 such that a curve or slope exists along the band 314 at the endpoint 452. Moreover, the concavity of the body portion 451 between the step portion 320 and the trailing edge 505 (shown in FIG. 4B) may be 0. Additionally, or alternatively, a curve or slope may exist along the body portion 451 such that the concavity of the body portion is greater than or less than 0. Moreover, the concavity along the body portion 451 may vary.

Accordingly, including a forward facing step on an inner band of the turbine section adjacent the combustion section of a turbine engine may create a stagnation region for airflow that prevents bow waves. The stagnation region may increase the static pressure within a cavity adjacent the forward facing step to resist a bow wave creation and prevent a reversal of airflow caused by the bow wave from entering the cavity. Without the stagnation region, gases, such as hot combustion gases, may be ingested into the cavity, which undesirably increases the temperature of the turbine engine components. Therefore, the forward facing step also reduces the need for additional cooling components of the turbine engine and improves the durability of such components.

Further aspects are provided by the subject matter of the following clauses:

An assembly for a gas turbine engine including a compressor section, a combustion section, and a turbine section in serial flow order and at least partially defining a working gas flow path, the assembly comprising: an inner liner and an outer liner spaced from the inner liner, the inner liner and the outer liner defining a combustion chamber of the combustion section, the combustion chamber defining at least a portion of the working gas flow path; an inner band and an outer band spaced apart from the inner band and defining at least a portion of the working gas flow path within the turbine section, wherein the inner band includes a first curve adjacent an upstream end and a second curve adjacent the first curve, the second curve opposite the upstream end; and a plurality of airfoils extending into the working gas flow path from the inner band, the outer band, or both the inner band and the outer band.

The assembly of any preceding clause, wherein: the upstream end of the inner band extends at least partially into the working gas flow path.

The assembly of any preceding clause, wherein at least a portion of the second curve is between the first curve and the plurality of airfoils.

The assembly of any preceding clause, wherein: the first curve comprises a convex shape; and the second curve comprises a concave shape.

The assembly of any preceding clause, wherein: the first curve comprises a negative concavity; and the second curve comprises a positive concavity.

The assembly of any preceding clause, wherein the inner liner and the inner band define a cavity between the combustion section and the turbine section.

The assembly of any preceding clause, wherein: a first portion of fluid flowing through the working gas flow path creates a stagnation region adjacent the upstream end of the inner band; and the stagnation region pressurizes the cavity such that the cavity defines a high pressure zone.

The assembly of any preceding clause, wherein: the stagnation region and the high pressure zone prevent a second portion of fluid flowing through the working gas flow path from entering the cavity; and the stagnation region and the high pressure zone direct the second portion of the fluid away from the cavity and along the working gas flow path.

The assembly of any preceding clause, wherein: the first curve and the second curve of the inner band comprise a step portion; and the step portion includes a step length; the plurality of airfoils includes an upstream end and a downstream end opposite the upstream end; the plurality of airfoils includes a tangency point between the upstream end and the downstream end; the tangency point is spaced from the upstream end of the inner band a tangency distance; and a ratio of the step length over the tangency distance is greater than or equal to 0.05 and less than or equal to 1.

The assembly of any preceding clause, wherein the inner band comprises: a peak distance between the upstream end of the inner band and a peak of the first curve; and a first curve length between the upstream end of the inner band and an end of the first curve adjacent the second curve.

The assembly of any preceding clause, wherein: a ratio of the peak distance over the first curve length is greater than or equal to 0.1 and less than or equal to 1.

The assembly of any preceding clause, wherein the outer band comprises the first curve adjacent the upstream end of the outer band and the second curve adjacent the first curve.

A gas turbine engine, comprising: a compressor section; a combustion section, the combustion section comprising: an inner liner, and an outer liner spaced from the inner liner, the inner liner and outer liner at least partially defining a combustion chamber; and a turbine section comprising: an inner band extending between an upstream side and a downstream side opposite the upstream side, an outer band spaced from the inner band and extending between the upstream side and the downstream side, the inner band and outer band at least partially defining a working gas flow path, wherein one or both of the inner band and the outer band include a step portion adjacent the upstream side and a body portion extending from the step portion to the downstream side, and wherein the step portion extends in a radial direction past the body portion, and a plurality of airfoils extending into the working gas flow path from the inner band, the outer band, or both the inner band and the outer band; wherein the compressor section, the combustion section, and the turbine section are in serial flow order and define at least a portion of the working gas flow path.

The gas turbine engine of any preceding clause, wherein the inner band includes the step portion; and the step portion at least partially extends into the working gas flow path.

The gas turbine engine of any preceding clause, wherein at least a portion of the step portion comprises a concave shape.

The gas turbine engine of any preceding clause, wherein the step portion comprises a first curve and a second curve.

The gas turbine engine of any preceding clause, wherein at least a portion of the second curve is between the first curve and the plurality of airfoils.

The gas turbine engine of any preceding clause, wherein the first curve is different from the second curve.

The gas turbine engine of any preceding clause, wherein: the first curve comprises a convex shape; and the second curve comprises a concave shape.

The gas turbine engine of any preceding clause, wherein: the first curve comprises a negative concavity; and the second curve comprises a positive concavity.

The gas turbine engine of any preceding clause, wherein: the inner band comprises a peak distance between the upstream side of the inner band and a peak of the first curve; the inner band comprises a first curve length between the upstream side of the inner band and an end of the first curve adjacent the second curve; and a ratio of the peak distance over the first curve length is greater than or equal to 0.1 and less than or equal to 1.

The gas turbine engine of any preceding clause, wherein the inner liner and the inner band define a cavity between the combustion section and the turbine section.

The gas turbine engine of any preceding clause, wherein the combustion section further comprises a seal disposed between the inner liner and the inner band, the seal defining at least a portion of the cavity.

The gas turbine engine of any preceding clause, wherein a first portion of fluid flowing through the working gas flow path creates a stagnation region adjacent the upstream end of the inner band.

The gas turbine engine of any preceding clause, wherein the stagnation region pressurizes the cavity such that the cavity defines a high pressure zone.

The gas turbine engine of any preceding clause, wherein the stagnation region and the high pressure zone prevent a second portion of fluid flowing through the working gas flow path from entering the cavity.

The gas turbine engine of any preceding clause, wherein the stagnation region and the high pressure zone direct the second portion of fluid away from the cavity and along the working gas flow path.

The gas turbine engine of any preceding clause, wherein: the step portion includes a step length; the plurality of airfoils includes an upstream end and a downstream end opposite the upstream end; the plurality of airfoils includes a tangency point between the upstream end and the downstream end; the tangency point is spaced from the upstream end of the inner band a tangency distance; and a ratio of the step length over the tangency distance is greater than or equal to 0.05 and less than or equal to 1.

The gas turbine engine of any preceding clause, wherein a concavity of the body portion is 0.

The gas turbine engine of any preceding clause, wherein a concavity of at least a portion of the body portion is greater than 0.

The gas turbine engine of any preceding clause, wherein a concavity of at least a portion of the body portion is less than 0.

The gas turbine engine of any preceding clause, wherein: the outer band includes the step portion; and the step portion at least partially extends into the working gas flow path.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

We claim:

1. A gas turbine engine, comprising:
a compressor section;
a combustion section, the combustion section comprising:
an inner liner, and
an outer liner spaced from the inner liner, the inner liner and outer liner at least partially defining a combustion chamber; and
a turbine section comprising:
an inner band extending between an upstream side and a downstream side opposite the upstream side,
an outer band spaced from the inner band and extending between the upstream side and the downstream side, the inner band and outer band at least partially defining a working gas flow path, wherein the upstream side of one or both of the inner band and the outer band includes a step portion and a body portion extending from the step portion towards the downstream side, the step portion extends past the body portion and into the working gas flow path, and
a plurality of airfoils extending into the working gas flow path from the inner band, the outer band, or both the inner band and the outer band;
wherein the compressor section, the combustion section, and the turbine section are in serial flow order and define at least a portion of the working gas flow path.

2. The gas turbine engine of claim 1, wherein both the inner band and the outer band include the step portion at the upstream side.

3. The gas turbine engine of claim 1, wherein at least a portion of the step portion comprises a concave shape.

4. The gas turbine engine of claim 1, wherein:
the step portion comprises a first curve and a second curve;
at least a portion of the second curve is between the first curve and the plurality of airfoils;
the first curve comprises a convex shape; and
the second curve comprises a concave shape.

5. The gas turbine engine of claim 4, wherein:
one or both of the inner band and the outer band comprise a peak distance between the upstream side of the inner band and the outer band and a peak of the first curve;
one or both of the inner band and the outer band comprise a first curve length between the upstream side of the inner band and the outer band and an end of the first curve adjacent the second curve; and
a ratio of the peak distance over the first curve length is greater than or equal to 0.1 and less than or equal to 1.

6. The gas turbine engine of claim 4, wherein:
one or both of the inner band and the outer band comprise a peak distance between the upstream side of the inner band and the outer band and a peak of the first curve;
each of the plurality of airfoils include an upstream end, a downstream end opposite the upstream end, and an airfoil length defined between the upstream end and the downstream end; and
the peak distance is greater than or equal to 0.01 times the airfoil length and less than or equal to 0.4 times the airfoil length.

7. The gas turbine engine of claim 4, wherein the step portion defines an inflection point between the first curve and the second curve, the inflection point is downstream of a peak of the first curve and upstream of the plurality of airfoils.

8. The gas turbine engine of claim 1, wherein the inner liner and the inner band define a cavity between the combustion section and the turbine section.

9. The gas turbine engine of claim 8, wherein the combustion section further comprises a seal disposed between the inner liner and the inner band, the seal defining at least a portion of the cavity.

10. The gas turbine engine of claim 9, wherein a first portion of fluid flowing through the working gas flow path creates a stagnation region adjacent the upstream side of the inner band, and wherein the stagnation region pressurizes the cavity such that the cavity defines a high pressure zone.

11. The gas turbine engine of claim 10, wherein the stagnation region and the high pressure zone prevent a second portion of fluid flowing through the working gas flow path from entering the cavity.

12. The gas turbine engine of claim 11, wherein the stagnation region and the high pressure zone direct the second portion of fluid away from the cavity and along the working gas flow path.

13. The gas turbine engine of claim 1, wherein:
the step portion includes a step length;
the plurality of airfoils includes an upstream end and a downstream end opposite the upstream end;
the plurality of airfoils includes a tangency point between the upstream end and the downstream end;
the tangency point is spaced from the upstream end of the inner band a tangency distance; and
a ratio of the step length over the tangency distance is greater than or equal to 0.05 and less than or equal to 1.

14. The gas turbine engine of claim 1, wherein a concavity of the body portion is 0.

15. The gas turbine engine of claim 1, wherein a concavity of at least a portion of the body portion is greater than 0.

16. The gas turbine engine of claim 1, wherein a concavity of at least a portion of the body portion is less than 0.

17. The gas turbine engine of claim 1, wherein the step portion comprises a substantially vertical face at a leading edge of the upstream side of one or both of the inner band and the outer band.

18. The gas turbine engine of claim 1, wherein the step portion extends continuously about the upstream side.

19. The gas turbine engine of claim 1, wherein the step portion has a constant cross-section in a circumferential direction about a longitudinal centerline axis of the gas turbine engine.

20. The gas turbine engine of claim 1, wherein the step portion is axisymmetric about a longitudinal centerline axis of the gas turbine engine.
